(19) United States
(12) Patent Application Publication
(10) Pub. No.: US 2005/0163023 A1
(43) Pub. Date: Jul. 28, 2005

(54) Optical data storage medium

(75) Inventor: Ronald Joseph Antonius Van Den Oetelaar, AA Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/509,455

(22) PCT Filed: Apr. 1, 2003
(86) PCT No.: PCT/IB03/01394

(30) Foreign Application Priority Data
Apr. 2, 2002 (EP) 02076288.6

(51) Int. Cl. G11B 7/24

(52) U.S. Cl. 369/275.1; 369/94

(57) ABSTRACT

An optical data storage medium (20) for recording by means of a focused radiation beam (9) is described. The beam enter the medium through a first plastic/resinous layer (1) which is transparent for the radiation beam (9). The medium further comprises at least a first recording stack (2), comprising a first recording layer, being present proximate the first plastic/resinous layer, and a second recording slick (4), comprising a second recording layer, said second recording stack (4) being present at a position more remote from the first plastic/resinous layer (1) than the first recording stack (2), and a transparent spacer layer (3) between the first and the second recording stack having a thickness larger than the depth of focus of the focused radiation beam. A first optically transparent thermal barrier layer (1) is interposed between the first recording stack (2) and the first plastic/resinous layer (1) by which it is achieved that the medium does not or hardly suffer from stress birefringence in the first plastic/resinous layer (1) caused by the radiation beam. A double sided version of the medium includes a third and fourth recording stack and a second optically transparent thermal barrier layer.

The invention relates to an optical data storage medium for recording by means of a focused radiation beam entering the medium through a first plastic/resinous layer which is transparent for the radiation beam, said medium further comprising at least:
a first recording stack, comprising a first recording layer, being present proximate the first the first plastic/resinous layer,
a second recording stack, comprising a second recording layer, said second recording stack being present at a position more remote from the first plastic/resinous layer than the first recording stack,
a transparent spacer layer between the first and the second recording stack having a thickness larger than the depth of focus of the focused radiation beam.

An embodiment of an optical recording medium as described in the opening paragraph is known from Japanese Patent Application JP-11066622.

Recently the Digital Versatile Disk (DVD) has gained market share as a medium with a much higher data storage capacity than the Compact Disc (CD). Presently, this format is available in a read only (ROM), recordable (R) and a rewritable (RW) version. For recordable and rewlitable DVD, there are at present several competing formats: DVD+R, DVD-R for recordable and DVD+RW, DVD-RW, DVD-RAM for rewritable. An issue for both the recordable and rewritable DVD formats is the limited capacity and therefore recording time because only single-stacked media are present with a maximum capacity of 4.7 GB. Note that for DVD-Video, which is a ROM disk, dual layer media with 8.5 GB capacity, often referred to as DVD-9, already have a considerable market share. Consequently, recordable and rewritable DVD's with 8.5 GB capacity are highly desired. A dual-layer, i.e. dual-stack, recordable and/or rewritable DVD disk is probably feasible. The DVD-ROM standard specification describes both a single-stack disk (type A; data capacity=4.7 GB) as well as a dual-stack disk (type C; data capacity=8.5 GB). Furthermore, a double-sided version of the single-stack disk (type B; data capacity=9.4 GB) and a double-sided version of the dual-stack disk (type D; data capacity=17.0 GB) are described. Recordable, i.e. write once, and/or rewritable media which are compatible with the DVD-ROM standard are highly desirable. Recently a new format has been introduced called Blu-ray Disc (BD) with even a higher storage capacity. This system uses a radiation beam wavelength of about 405 nm and has a relatively high numerical aperture (NA) of the focused radiation beam. For this format also write once (R) and rewritable (RW) versions will be introduced, and dual-layer BD versions are considered.

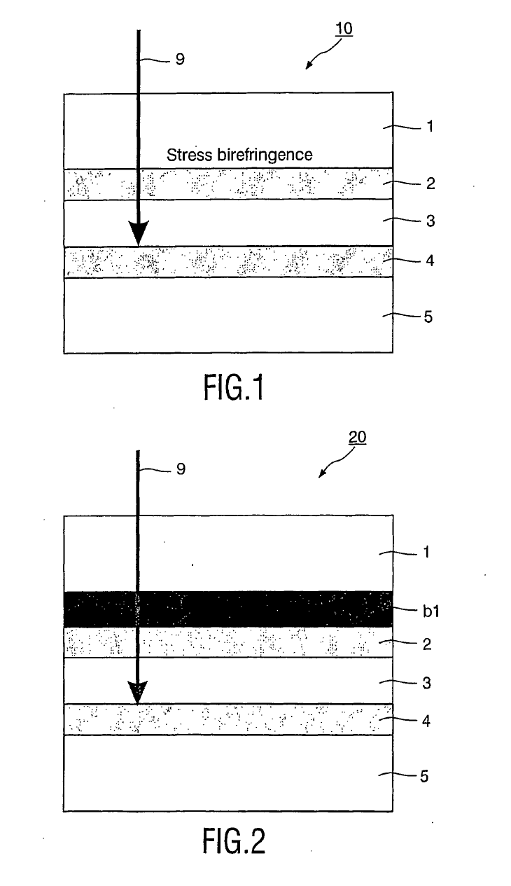

In order to access the second recording stack, also called L1 recording stack (see nr 4 in FIG. 1), of a dual-layer DVD+R, dual-layer DVD+R+RW or dual-layer DVD+R-ROM optical storage medium, the radiation beam must be focused onto the recording layer of the L1 stack through three layers, i.e. the upper polycarbonate substrate, the first recording stack, also called L0 recording stack, and the spacer layer (see respectively nr 1, 2 and 3 in FIG. 1). Optical disturbances inside or at the interface of any of these three layers will deteriorate the optical recording signal and may even prevent reading or writing on the L1 layer. In the known medium, heat absorption in the L0 dye layer during writing on L0 may induce stress in the polycarbonate near the substrate-dye interface, thus inducing stress birefringence, also called mechanical birefringence or photoelasticity, in the upper substrate, which is the first plastic or resinous layer. The induced birefringence in the upper polycarbonate substrate may prevent to obtain a sufficiently small focused laser spot on the lower L1 layer, and will also adversely affect the reflected laser beam from the L1 layer.

Single-stack DVD+R media, and similarly CD-R media, are much less affected by the problem discussed above, since the induced stress birefringence in the polycarbonate at the substrate-dye interface is near the radiation beam focal point, in contrast to a dual-layer medium, in which the radiation beam is well out of focus at the affected polycarbonate area (with stress birefringence) while focusing on the L1 layer.

It is an object of the invention to provide an optical data storage medium of the type mentioned in the opening paragraph which does not or hardly suffer from stress birefringence in the first plastic/resinous layer caused by the radiation beam.

This object is achieved by an optical storage medium as described in the opening paragraph which is characterized in that a first optically transparent thermal barrier layer is interposed between the first recording stack and the first plastic/resinous layer.

A first thermal barrier layer between the first recording stack, i.e. the upper L0 recordable stack, and the first plastic/resinous layer, e.g. the upper polycarbonate substrate, is proposed for use in a single-sided and double-sided dual-layer DVD+R, DVD+R+RW and DVD+R-ROM optical storage medium. The thermal barrier layer will eliminate stress birefringence in the upper polycarbonate substrate upon writing in the upper L0 layer, thus allowing optimum optical access to the lower L1 layer.

Preferably the first recording layer is a write once layer and the second recording layer is one selected from a write once layer, a rewritable layer and a read only layer. The latter has been recorded during manufacture of the masterdisk. Such a write once layer has the advantage that a relatively high transmission of the first recording stack can be achieved. This high transmission enables an optical storage medium with an effective optical reflection of higher than 18% for both the first and the second recording stack, which is one of the requirements of the DVD read only standard.

Preferably, the first thermal barrier layer is made of a material with a low thermal conductivity, e.g. smaller than 1 W/mK. The material should be optically transparent for the radiation beam, i.e. the optical absorption parameter k should be zero or close to zero, e.g. <<0.01, at a wavelength λ of the focused radiation beam, e.g. λ=655 nm for DVD. Preferably, the material has a low mechanical stress and is sufficiently thick, preferably in the range of 1-500 nm, more preferably in the range of 5-50 nm, thereby reducing the temperature at the barrier layer-substrate interface in order to prevent mechanical distortion of the first plastic/resinous layer, e.g. made of polycarbonate material. Suitable materials for the thermal barrier layer are e.g. ZnS—SiO₂, silicon oxynitride and silicon oxide.

The thermal barrier layer may also help to increase the recording sensitivity of the upper L0 stack. Since the L0 stack has a high transmittivity, which is necessary to enable a sufficient part of the radiation beam to reach the lower L1 stack, the energy of the radiation beam should be efficiently used while recording on L0. The thermal barrier layer will diminish the leaking of heat to the upper plastic/resinous substrate, thus making the L0 recordable stack more sensitive.

In another embodiment the optical data storage medium further comprises
a second plastic/resinous layer transparent for the radiation beam, opposite from the first plastic/resinous layer,
a third recording stack, comprising a third recording layer, being present proximate the second plastic/resinous layer,
a fourth recording stack, comprising a fourth recording layer, said fourth recording stack being present at a position more remote from the second plastic/resinous layer than the third recording stack,
a transparent spacer layer between the third and the fourth recording stack having a thickness larger than the depth of focus of the focused radiation beam
a second optically transparent thermal barrier layer, interposed between the third recording stack and the second plastic/resinous layer. In this way a double sided optical recording medium is achieved with a double data storage capacity of the single sided medium.

The invention will be elucidated in greater detail with reference to the accompanying drawings, in which

FIG. 1 shows a schematic layout of an embodiment of a dual-stack optical data storage medium according to prior art.

FIG. 2 shows a schematic layout of an embodiment of a dual-stack optical data storage medium according to the invention,

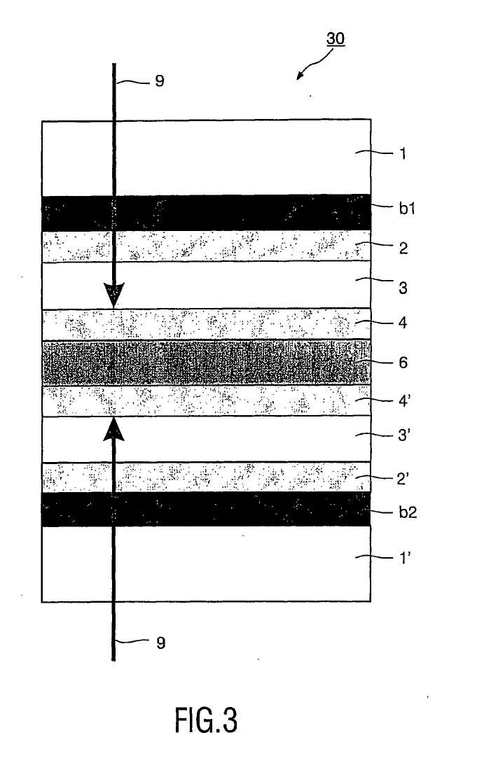

FIG. 3 shows a schematic layout of another embodiment of a double sided dual-stack optical data storage medium according to the invention.

### COMPARATIVE EXAMPLE

### Prior Art

In FIG. 1 an optical data storage medium 10, according to prior art, for recording by means of a focused radiation beam 9 is shown. The radiation beam 9 has a wavelength of 655 nm and enters the medium 10 through a first plastic/resinous layer 1, made of polycarbonate, transparent for the radiation beam 9. The medium filter comprises a first recording stack 2, comprising a first recording layer, being present proximate the first plastic/resinous layer and a second recording stack, comprising a second recording layer, said second recording stack 4 being present at a position more remote from the first plastic/resinous layer 1 than the first recording stack. A transparent spacer layer 3 is present 7 between the first and the second recording stack having a thickness between 40 and 70 μm, larger than the depth of focus of the focused radiation beam. The first and second recording layer are azo dye layers. The first and second recording stack further comprise reflective layers, respectively e.g. a thin semi transparent metal layer of 10 mm Ag and a relatively thick metal layer of 100 nm Ag.

### EXAMPLES ACCORDING TO THE INVENTION

In FIG. 2 an optical data storage medium 20 is shown wherein, according to the invention, a first optically transparent thermal barrier layer b1, interposed between the first recording stack 2 and the first plastic/resinous layer 1, is added to the optical data storage medium 10 as described with FIG. 1. The thermal barrier layer b 1 mainly comprises SiO₂ and has a thickness of 20 nm and is deposited by e.g. sputtering. The first plastic/resinous layer 1, a substrate made of polycarbonate, has a servo pregroove pattern and a thickness in the range of 550-600 μm. The servo pregroove is used for guiding the focused radiation beam 9 during recording and/or read out. First recording stack 2 is a write once stack comprising a first recording layer made of a cyanine dye or azo dye (n=2.2; k=0.02) having a thickness of 80 nm. The dye may be deposited by spincoating or evaporation. A semi transparent reflective layer of Au (n=0.28; k=3.9) having a thickness of 8 nm is present between the first recording layer and the spacer layer 3 and deposited by e.g. sputtering. The transparent spacer layer 3 is made of an UV-curable resin or a pressure-sensitive adhesive (PSA) (n=1.5) with a thickness of 40-70 μm. The second recording stack 4 comprises, in this order, a first dielectric layer made of ZnS/SiO2 (80: 20) (n=2.15) having a thickness of 135 nm and deposited by sputtering, a rewintable recording layer made of a phase-change GeInSbTe alloy (crystalline: n=2.9; k=4.8) having a thickness of 12 nm and deposited by sputtering, a second dielectric layer made of ZnS/SiO2 (80: 20) (n=2.15) having a thickness of 23 nm and deposited by sputtering, a reflective layer made of Al (n=1.97; k=7.83) having a thickness of 100 nm and deposited by sputtering. A further substrate 5, made of polycarbonate (n=1.58) and having a thickness of in the range of 550-650 μm, is present adjacent the second recording stack 4. The further substrate 5 has a servo pregroove or guide groove pattern in its surface at the side of the second layer stack 4. In another embodiment, a servo pregroove or guide groove pattern is present in the transparent spacer layer 3, at the side of the second layer stack 4. The second recording stack 4 comprises, in this order, a write once recording layer made of an azo or cyanine dye (n=2.2; k=0.02) having a thickness of 80 nm and a reflective layer made of Ag (n=0.28; k=3.8) having a thickness of 100 nm and deposited by sputtering.

In FIG. 3 a double sided dual stack optical data storage medium 30 according to the invention is shown which is compatible with the type D DVD-ROM standard. Reference numerals 1, 2, 3, 4 and b1 correspond to the description of FIG. 2. The first transparent spacer layer 3, made of an UV-curable resin, has a servo pregroove or guide groove pattern in its surface at the side of the second layer stack 4. Further substrate S of FIG. 2 is replaced by a coupling layer 6.

The medium 30 further comprises:
a second plastic/resinous layer 1′ transparent for the radiation beam 9, opposite from the first plastic/resinous layer 1,
a third recording stack 2′, comprising a third recording layer, being present proximate the second plastic/resinous layer 1′,
a fourth recording stack 4′, comprising a fourth recording layer, said fourth recording stack 4′ being present at a position more remote from the second plastic/resinous layer 1′ than the third recording stack 2′,
a second transparent spacer layer 3′ between the third and the fourth recording stack having a thickness in the range of 40-70 μm.
a second optically transparent thermal barrier layer b2, interposed between the third recording stack 2′ and the second plastic/resinous layer 1′.

The layers and stacks 1′, 2′, 3′, 4′ and b2 are identical to respectively the layers and stacks 1, 2, 3, 4 and b2. Hence a double sided dual stack medium is provided with identical design on both sides bonded together by coupling layer 6 which may be a PSA with a thickness of 20-300 μm. Depending on the thickness of the substrates 1 and 1′ and the spacer layers 3 and 3′, the thickness of the coupling layer 6 may be adjusted in order to have the total thickness of the medium 30 not exceed the maximum thickness as specified in the DVD disk standard, i.e. 1500 μm. The thickness range of the substrate however is also limited in order to prevent occurrence of excessive optical aberrations in the focused radiation beam 9 used for reading and writing in the recording layers.

The pregroove (or guide groove) of the second recording stack 4 and the fourth recording stack 4′ may also be present in the coupling layer 6 in which case the coupling layer may constitute a sheet of plastic with pregrooves on both sides. In this case, spacer layers 3 and 3′ may constitute a UV-curable resin or pressure-sensitive adhesive (PSA) without pregroove.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

According to the invention an optical data storage medium for recording by means of a focused radiation beam is described. The beam enters the medium through a first plastic/resinous layer which is transparent for the radiation beam. The medium further comprises at least a first recording stack, comprising a first recording layer, being present proximate the first plastic/resinous layer, and a second recording stack, comprising a second recording layer, said second recording stack being present at a position more remote from the first plastic/resinous layer than the first recording stack, and a transparent spacer layer between the first and the second recording stack having a thickness larger than the depth of focus of the focused radiation beam. A first optically transparent thermal barrier layer is interposed between the first recording stack and the first plastic/resinous layer by which it is achieved that the medium does not or hardly suffer from stress birefringence in the first plastic/resinous layer caused by the radiation beam. A double sided version of the medium includes a third and fourth recording stack and a second optically transparent thermal barrier layer.

1. An optical data storage medium (20) for recording by means of a focused radiation beam (9) entering the medium through a first plastic/resinous layer (1) which is transparent for the radiation beam (9), said medium further comprising at least:
a first recording stack (2), comprising a first recording layer, being present proximate the first plastic/resinous layer,
a second recording stack (4), comprising a second recording layer, said second recording stack (4) being present at a position more remote from the first plastic/resinous layer (1) than the first recording stack (2),
a transparent spacer layer (3) between the first and the second recording stack having a thickness larger than the depth of focus of the focused radiation beam characterized in that a first optically transparent thermal barrier layer (b 1) is interposed between the first recording stack and the first plastic/resinous layer.

2. An optical data storage medium (20) as claimed in claim 11, wherein the first recording layer is a write once layer and the second recording layer is one selected from a write once layer, a rewritable layer and a read only layer.

3. An optical data storage medium (20) as claimed in any one of claims 1 or 2, wherein the thermal barrier layer has an optical absorption k<0.01 at a wavelength), of the focused radiation beam.

4. A dual stack optical data storage medium (20) as claimed in any one of claims 1-3, wherein the thermal barrier layer has a thermal conductivity smaller than 1 W/mK.

5. An optical data storage medium (20) as claimed in any one of claims 1-4, wherein the thermal barrier layer has a thickness in the range of 11-500 nm.

6. An optical data storage medium (20) as claimed in claim 5, wherein the thermal barrier layer has a thickness in the range of 5-50 nm.

7. An optical data storage medium (20) as claimed in any one of claims 1-6, wherein the thermal barrier layer mainly comprises a material selected from the group of ZnS—SiO₂, silicon oxynitride and silicon oxide.

8. An optical data storage medium (30) as claimed in any one of claims 1-7, wherein the medium further comprises at least:
a second plastic/resinous layer (1′) transparent for the radiation beam (9), opposite from the first plastic/resinous layer (1),
a third recording stack (2′), comprising a third recording layer, being present proximate the second plastic/resinous layer,
a fourth recording stack (4′), comprising a fourth recording layer, said fourth recording stack being present at a position more remote from the second plastic/resinous layer (1′) than the third recording stack (2′),
a transparent spacer layer (3′) between the third and the fourth recording stack having a thickness larger than the depth of focus of the focused radiation beam
a second optically transparent thermal barrier layer (b2), interposed between the third recording stack and the second plastic/resinous layer.
